(19) United States
(12) Patent Application Publication
(10) Pub. No.: US 2006/0078668 A1
(43) Pub. Date: Apr. 13, 2006

(54) Stable aqueous suspension of insoluble protein

(76) Inventor: Jette Thoegersen, Karlslunde (DK)

Correspondence Address: J. M. Huber Corporation, 333 Thornall Street, Edison, NJ, 08837-2220, US

(21) Appl. No.: 11/218,016

(22) Filed: Sep. 1, 2005

Related U.S. Application Data
(60) Provisional application No. 60/607,061, filed on Sep. 3, 2004.

(51) Int. Cl. A23J 1/00

(52) U.S. Cl. 426/656

(57) ABSTRACT

Disclosed is a process of producing an essentially stable aqueous suspension of protein wherein the aqueous suspension of protein is directly acidified, comprising the steps of: obtaining a protein material, dispersing the protein material in an aqueous protein dispersion to form an initial homogenized aqueous protein dispersion, adding an effective amount of stabilizer to the initial homogenized aqueous protein dispersion, acidifying the initial homogenized aqueous protein dispersion and homogenizing the initial homogenized aqueous protein dispersion to form an essentially stable aqueous suspension of protein.

### FIELD OF THE INVENTION

The present invention relates to a process for manufacturing essentially stable suspensions of water-insoluble proteins, useful in producing beverages, which will minimize the amount of protein separation from the beverage during storage. The present invention is particularly useful in producing essentially stable suspension of water-insoluble soy proteins in pH ranges of 4.6 or below.

### BACKGROUND OF THE INVENTION

This invention relates to the manufacture of essentially stable suspensions of water-insoluble protein, more particularly, this invention relates to beverages in which water-insoluble protein is suspended at the pH below about 4.6, more preferably in the pH range of from about 3.5 to 4.5, a range that is typical of fruit juices and soft drinks.

Several kinds of proteins are insoluble when subjected to relatively low pH, for example a pH below 4.6, in aqueous systems. This phenomenon may be observed for example when one mixes milk and orange juice together. When such mixtures are produced, there is a tendency for two or more macroscopically distinct phases to be formed and a separation is observed. It may be observed that the blend when it is poured from a glass leaves grainy residues on the wall of the glass, and the feeling in the mouth is “grainy”. On prolonged standing, the milk/orange juice mixture exhibits visible lumps and a much thinner supernatant, which in context with beverages would be considered unappealing. All of these product defects become worse if the mixture would be heat-treated (which is typically done for achieving a long shelve-life of beverages). Stability of suspensions in the sense that they remain visibly homogeneous and do not have to be re-suspended by shaking is a general desire, not only with beverages, but also for many other suspensions, for example, medicines.

It is well known that the stability of low-pH protein suspensions can be improved by adding an appropriate stabilizer, typically HM-pectin (Glahn 1982, Parker et a!. 1993, Glahn & Rolin 1994, Christensen et al. 1996, Boulenguer et a!. 2003, Christensen et al. 2004). The technology described in these documents has been successful with respect to stabilizing beverages with which the protein part is based on fermented milk. In U.S. Pat. No. 6,759,067, a method for producing acidic milk beverages characterized by homogenizing fermented milk, adding a hemicellulose to stabilize the fermented milk and subsequently homogenizing the fermented milk again to produce a stabilized milk product is disclosed.

Stabilization of protein that has not been acidified by fermentation prior to making the final suspension known.

Products, which are prepared with protein that has not been acidified in a separate process prior to the making of the essentially liquid suspension, are referred to as “directly acidified” (Glahn & Rolin 1994). The option of using protein that is not of milk origin, soy protein for example, has also been published (Glahn & Rolin 1994). Beverages prepared according to the descriptions of these prior art documents are clearly more stable than beverages prepared without using a stabilizer, however beverages produced by direct acidification are not as stable as beverages which are based upon fermented milk.

U.S. Pat. No. 5,807,603 to lerchenfeld, et al., discloses a method and stabilizer system for preventing the separation of solids in juice-containing products. Propylene glycol alginate and sodium carboxymethyl cellulose are blended with hot water to form a slurry which is to be added to a fruit concentrate. Prior to reconstitution with water, the slurry-concentrate is to be homogenized.

U.S. Pat. No. 4,163,807 to Jackinan, discloses a method of improving the appearance, taste and stability of citrus fruit juice and drinks by incorporating xanthan gum and carboxymethyl cellulose. In particular, the combined gums unproved the suspension of the pulp in the citrus juice and drinks during storage up to 7 days. The addition of xanthan gum alone to the beverages was found to bring about cloud destabilization and pulp flocculation.

U.S. Pat. No. 5,248,515 to Payton, et al., discloses a process for preparing a vegetable fine-grind puree to which a fruit juice is added with the resulting beverage having a vegetable solids content of from about 1% to about 4% by weight of the product. The process comprises of comminution of cooked vegetables so that the particles of the puree can pass through a 80-mesh screen. The puree-fruit juice mixture is to be homogenized.

U.S. Pat. No. 6,759,067 to Ogasawara, et al., discloses a method for producing acidic milk beverages, characterized by homogenizing fermented milk, then adding water-soluble hemicellulose thereto for mixing, followed by an additional step of homogenization. The method provides stable acidic milk beverages which undergo less sedimentation or separation of whey during product storage, and which have favorable flavor.

U.S. Pat. No. 4,391,830 to Gudnason, et al., discloses the use of a high methoxyl pectin, which is added to an already prepared yogurt to produce a substantially physically and microbiologically stable liquid yogurt. Said pectin is dispersed and dissolved in said yogurt in a manner which avoids the need for high-pressure homogenization and subsequent heat treatment thereto to eliminate contaminants.

There remains a need for a process for producing essentially stable aqueous suspensions of proteins which are “directly acidified”, as opposed to being “indirectly acidified” through fermentation, and which may be subsequently used to produce beverages containing these essentially stable aqueous suspensions of proteins which exhibit similar stability as those products which are based upon fermented milk, more particularly products wherein the proteins are soy proteins.

### BRIEF DESCRIPTION OF THE INVENTION

The present invention relates to a process of producing an essentially stable aqueous suspension of protein wherein the aqueous suspension of protein is directly acidified comprising the steps of; obtaining a protein material, dispersing the protein material in an aqueous solution comprising water to form an aqueous protein dispersion, homogenizing the aqueous protein dispersion to form an initial homogenized aqueous protein dispersion, adding an effective amount of a stabilizer to the initial homogenized aqueous protein dispersion, acidifying the initial homogenized aqueous protein dispersion and homogenizing the initial homogenized aqueous protein dispersion to form an essentially stable aqueous suspension of protein.

The protein material of use in the above-mentioned process may be selected from the list consisting of soy proteins, milk proteins and egg proteins, more preferably the soy protein is a soy protein isolate.

The stabilizers of use in the above-mentioned process may be selected from the from the group consisting of pectin, carrageenan, soybean fiber, carboxyl methyl cellulose (CMC), and propylene glycol alginates (PGA), more preferably the stabilizer comprises a pectin.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 shows the sediment% of a soy protein beverage containing the YM-150-L pectin produced in a 1-step homogenization process versus the same beverage produced in a 2-step homogenization process;

FIG. 2 shows the sediment% of a soy protein beverage containing the #35 high ester pectin produced in a 1-step homogenization process versus the same beverage produced in a 2-step homogenization process; and

FIG. 3 shows the sediment% of a soy protein beverage containing the #47 high ester pectin produced in a 1-step homogenization process versus the same beverage produced in a 2-step homogenization process.

### DETAILED DESCRIPTION OF THE INVENTION

In respect to the use of the terms “mouth feel” and “organoleptic character” herein, it will be appreciated that such terms relate generally to a group of tactile impressions which, while common to the body as a whole, are particularly acutely perceived in the lingual, buccal and esophageal mucosal membranes. More precisely, the terms “mouth feel” and “organoleptic character” as used herein are in particular reference to those sensations associated with the tactile perception of fineness, coarseness, smoothness, and greasiness. Such tactile impressions are acutely appreciated in the oral cavity wherein subtle differences between various food and beverage textures are most readily perceived.

In respect to the use of the term “insoluble,” the term is defined herein as the characteristic of being visible to the unaided eye, when in an aqueous suspension. “Insoluble” particles can be precipitated or recovered upon centrifugation of an aqueous suspension.

In respect to the use of the term “suspension,” the term is defined herein as an aqueous medium that comprises an “insoluble” particle component as that term is defined above.

In respect to the use of the term “sediment,” the term is defined herein as an insoluble particle that is not in a stable suspension but rather precipitates out of the suspension over time through naturally occurring forces of gravity.

In respect to the use of the term “solution,” the term is defined herein as an aqueous medium that is substantially free of “insoluble” particles as that term is defined above. The term “supernatant phase” is an alternative term for “solution” and is to be attributed with the same meaning.

The present method is useful in providing stable suspensions of insoluble protein particles in which the insoluble protein particles are directly acidified, rather than indirectly acidified through fermentation. The insoluble proteins of interest in the present invention include milk proteins, egg proteins and vegetable proteins, most particularly, soy proteins.

Soy proteins are commonly available in numerous forms such as soybean meal; soyflour; de-fatted soyflour; soymilk, spray-dried soymilk; soy protein concentrate; texturized soy protein concentrate; hydrolyzed soy protein; and soy protein isolate.

A preferred form of soy for the present invention is in the form of soy protein isolate.

The term “soy protein isolates” as used herein refers to those products which are the major proteinaceous fraction of soybeans prepared from de-hulled soybeans by removing the majority of non-protein compounds and must contain not less than 90% protein on a moisture free basis.

The term “soy protein concentrates” as used herein refers to those products which are prepared from high quality sound, clean de-hulled soybean seeds by removing most of the oil and water soluble non-protein constituents and must contain not less than 65% protein on a moisture free basis.

The present invention produces protein suspensions of better stability than what can be achieved from previous methods. The term “stability” as used herein means absence of all of the following phenomena: visible deposition of particles on the surface of glass, as can be observed at the walls of a glass from which the suspension is poured; separation of a thinner and/or less hazy supernatant phase such as whey, for example, formation of lumps, which are characterized as an agglomeration of the smaller insoluble protein particles into a larger mass that is either visible or can be detected through its organoleptic character; formation of a sediment.

It has been surprisingly found that suspensions of particularly good stability result when certain operations are carried out in a specific sequence. Accordingly, the following process steps are performed.

First an insoluble protein is dispersed in water. Sufficient time and temperature is provided to allow for effective hydration of the insoluble protein. Mechanical mixing may be employed to aid in the hydration of the protein.

If it is necessary to grind the insoluble protein particles to prepare them for forming the suspensions of the present invention, it has been found that especially good results can be obtained using a micro-grinding mill available from Buehler, Ltd. of Uzwil, Switzerland.

Once the protein particles are sufficiently hydrated, the suspension is subjected to a first homogenization step. This homogenization step may be accomplished using any homogenizer commonly known in the art. This includes various commercially available one- or two-stage high-pressure homogenizers. One such homogenizer is available from either the Rannie or Gaulian divisions of APV, of Wilmington, Mass.

Homogenizers of the present invention may be run at operating conditions such as temperatures, pressures and through puts typically found in food processing industry.

The homogenizer may be run for the first homogenization step at total pressures up to 1000 bar, more preferably at total pressures up to 500 bar, more preferably at total pressures up to 250 bar, still more preferably at total pressures up to 225 bar.

After the first homogenization step, a stabilizer system is added to the homogenized protein suspension. The stabilizer system comprises a stabilizers be selected from the from the group consisting of pectin, carrageenan, soybean fiber, carboxy methyl cellulose (CMC), and propylene glycol alginates (PGA). More preferably the stabilizer comprises a pectin. The stabilizer system also includes other components, such as acids, which are added in combination with the stabilizer in effective amounts to increase the functionality of the stabilizer.

The preferred pectins for use in the present invention are high ester pectins; pectins with a degree of esterification (DE) of 50% or greater. More preferably the high ester pectins have a DE of from about 50% to 85% DE. Still more preferably, the high ester pectins have a DE of from about 60% to about 78%, still more preferably, the high ester pectins have a DE of from about 60% to 78% DE.

The protein suspension may then be directly acidified through the addition of acids.

Additional components may be added as needed to the suspension at this time, such as acids, sweeteners, colors, flavorings, nutrients and the like.

The acidified protein suspension is subjected to a second homogenization step to produce the stabilized protein suspension.

The homogenizer may be run for the second homogenization step at total pressures up to 1000 bar, more preferably at total pressures up to 500 bar, more preferably at total pressures up to 250 bar, still more preferably at total pressures up to 225 bar.

The first homogenization step and the second homogenization step may be performed by distinct homogenizers, or alternatively, the process for producing the stabilized protein suspension may contain a loop wherein material from the first homogenization step is returned to the same homogenizer for the second homogenization step.

The thus prepared suspension may optionally further be heat-treated so microorganisms are eliminated and a long shelve-life is ensured. This step is particularly useful if the product is to packaged or bottled.

Even with suspensions that are not beverages, it is usually desirable that different portions taken from the same container have identical composition. One example could be liquid medicines with which it is important that the correct dosage of the active component can be reliably administered by taking a prescribed volume of the suspension.

The present invention will next be described by way of examples. However, the invention is not limited only to the examples. Except where otherwise noted, all values listed are in grams and all percentages are calculated on a mass/mass basis.

### EXAMPLE 1

### Soy Protein Beverage

A soy protein beverage was prepared with the following ingredients:

| | Parts by |
|---|---|
| Materials | weight |
| Soy protein isolate type FXP H0220 obtained from Protein | 1.56 |
| Technologies International Inc. | |
| ˜1.36% protein in the final product | |
| De-ionized Water | 70 |
| High Ester Pectin GENU pectin type YM-100-L obtained from | 15 |
| CP Kelco ApS, 3% sol. | |
| ˜0.45% pectin in the final product | |
| High Fructose Syrup | 10 |
| Citric Acid, crystals | 0.5 |
| Phosphoric Acid (85%) | 0.05 |
| De-ionized Water | 2.9 |

The process for producing the soy beverage was as follows
Disperse soy isolate into 25° C. (77° F.) de-ionized water using high speed mixer
Hydrate for min. 30 minutes
Heat to min. 70° C. (158° F.), holding time 5 minutes.
Homogenize at 200/50 bar
Cool to ambient temperature before mixing with pectin solution
Disperse GENU pectin type YM-100-L into 50° C. (122° F.) de-ionized water using high-speed mixer and mix for approx. 5 minutes.
Cool the temperature by mixing with soy isolate
Add High Fructose syrup and mix for few minutes
Add Phosphoric Acid and Citric Acid Solution 50%
Adjust final pH to 3.8 with Citric Acid solution (temp. is approx. 25° C.(77° F.>>
Homogenize at 200/50 bar, total pressure 250 bar.
Heat to 85° C. (185° F.) in water bath while stirring, holding time 10 minutes at 85° C. (185° F.)
Fill the hot drink into bottles.
Cool to the storage temperature.

The beverage was stored under quiescent conditions at 41° C.I77° F. The beverage appeared stable with no indications of separation into parts of different composition. The sediment after a high-gravity centrifugation was 4.27%. The particle size d(0.5 μm) was 1.43 as determined by a particle size analyzer available from Malvern Products.

### EXAMPLE 2

### Soy Protein Beverage

A soy protein beverage was prepared with the following ingredients and using the following process:

Process:

1 Disperse Soy isolate powder into water and prepare 5% solution;
2 Hydration min. 30 minutes at ambient temperature;
3 Heat to 70° C. (158° F.) holding time 5 minutes;
4 Homogenize at 200/50 bar;
5 Cool to approx. 25° C. (77° F.), or cool to 5° C.(41 OF) until further use;
6 Mix the soy isolate solution with pectin solution, high ester pectin 68-74% DE. an<water as in Example 1;
7 Add sugar and mix for two minutes before acidification;
8 Add trisodium citrate (TNC) and acidify at approx. 25° C. (7rF) to pH 3.9;
9 Homogenize at 25° C. (77° F.) at 200/50 bar;
10 Pasteurize. at 70° C. (158° F.) for 10 minutes;
11 Fill into tarred sedimentation tubes, viscosity tube and Blue Cap bottle;
12 Measure sedimentation by centrifugation at 4500 rpm for 20 minutes −3000 G;
13 Empty the tubes after centrifugation. drain the liquid phase and weigh back Immediately, (the tubes can not be left upside down due to fluffy sediment);
14 Measure viscosity at 5° C. Brookfield Viscometer type L VT 60 rpm for 60 see;
15 Check pH; and
16 Check the particle size on Malvern—only on stable samples, if necessary.

### COMPARATIVE EXAMPLES

The following process was used to produce soy protein beverages as in Example 2, with the exception that only one homogenization step was performed.

Process:

1 Disperse Soy isolate powder into water and prepare 5% solution;
2 Hydration min. 30 minutes at ambient temperature;
3 Heat to 70° C. (158° F.) holding time 5 minutes;
4 Cool to approx. 25° C. (77° F.), or cool to 5° C. (41° F.) until further use;
5 Mix the soy isolate solution with pectin solution and water;
6 Add sugar and mix for two minutes before acidification;
7 Add 3 ml TNC and acidify with citric acid (approx. 6.5 ml) at approx. 25° C. (77° F.) to pH 3.9;
8 Homogenize at 25° C. (77° F.) at 200/50 bar;
9 Pasteurize. at 70° C. (158° F.) 10 minutes;
10 Fill into tarred sedimentation tubes, viscosity tube and Blue Cap bottle;
11 Measure sedimentation by centrifugation at 4500 rpm for 20 minutes −3000 G;
12 Empty the tubes after centrifugation, drain the liquid phase and weigh back; Immediately, the tubes can not be left upside down due to fluffy sediment;
13 Measure viscosity at 5° C. Brookfield Viscometer type L VT 60 rpm for 60 sec.;
14 Check pH;

15 Check the particle size on Malvern—only on stable samples, if necessary.

| | | | | | Viscosity | | | | |
|---|---|---|---|---|---|---|---|---|---|
| Lab test: | | Pectin | Sediment | Adjusted | cPs at | d(0, 1) | d(0, 5) | D(0, 9) | |
| Lab no | Pectin type/batch no | Conc. % | % | pH | 5° C. | um | um | um | Comments |
| 1 | Blind | 0 | 8.56 | 3.75 | | 8.169 | 17.791 | 38.842 | |
| 2 | | 0.075 | 11.18 | 3.57 | | | | | |
| 3 | | 0.100 | 12.02 | 3.6 | | | | | |
| 4 | YM-150-L | 0.125 | 13.77 | 3.64 | | | | | |
| 5 | High ester pectin | 0.150 | 16.21 | 3.66 | | 3.905 | 8.359 | 20.236 | |
| 6 | | 0.175 | 9.91 | 3.69 | 11.0 | 1.918 | 6.559 | 50.383 | |
| 7 | 20 g/l | 0.200 | 8.98 | 3.71 | 11.0 | 1.060 | 5.865 | 71.576 | |
| 8 | High ester pectin | 0.075 | 11.53 | 3.72 | | | | | |
| | (DE 68-74% #35) | | | | | | | | |
| 9 | | 0.100 | 13.74 | 3.73 | | | | | |
| 10 | | 0.125 | 13.86 | 3.72 | | 4.089 | 8.702 | 18.854 | |
| 11 | | 0.150 | 9.32 | 3.72 | 10 | 1.253 | 5.696 | 85.176 | |
| 12 | | 0.175 | 5.28 | 3.74 | 9.0 | 0.751 | 4.321 | 90.393 | |
| 13 | 20 g/l | 0.200 | 4.18 | 3.72 | 9.5 | 0.667 | 3.582 | 92.442 | |
| 14 | High ester pectin | 0.075 | 11.17 | 3.74 | | | | | |
| | (DE 68-74%) #47 | | | | | | | | |
| 15 | | 0.100 | 12.72 | 3.72 | | | | | |
| 16 | | 0.125 | 13.90 | 3.73 | | 5.276 | 11.231 | 24.557 | |
| 17 | | 0.150 | 11.15 | 3.73 | 10.5 | 1.715 | 6.561 | 66.394 | |
| 18 | | 0.175 | 6.37 | 3.76 | 9.0 | 0.879 | 5.011 | 83.742 | |
| 19 | 20 g/l | 0.200 | 4.26 | 3.76 | 10.0 | 0.691 | 3.800 | 93.259 | |

| | | | | | | Particle size - | | | |
|---|---|---|---|---|---|---|---|---|---|
| | Pectin | | | | Viscosity | Malvern test | | | |
| Lab test: | type/batch | Pectin | Sediment | Adjusted | cPs at | d(0, 1) | d(0, 5) | D(0, 9) | |
| Lab no | no | Conc. % | % | pH | 5° C. | um | um | um | Comments |
| 1 | Blind | 0 | 5.12 | 3.83 | | | | | |
| 2 | | 0.075 | 8.73 | 3.76 | | | | | |
| 3 | | 0.100 | 10.75 | 3.75 | | | | | |
| 4 | YM-150-L | 0.125 | 11.59 | 3.74 | | | | | |
| 5 | | 0.150 | 13.64 | 3.75 | | | | | |
| 6 | | 0.175 | 12.29 | 3.76 | | 2.905 | 7.269 | 16.704 | |
| 7 | 20 g/l | 0.200 | 3.59 | 3.76 | 9.0 | 0.546 | 3.113 | 98.245 | |
| 8 | High ester pectin | 0.075 | 14.53 | 3.75 | | | | | |
| | (DE 68-74% #35) | | | | | | | | |
| 9 | | 0.100 | 10.94 | 3.74 | | | | | |
| 10 | | 0.125 | 13.38 | 3.73 | | | | | |
| 11 | | 0.150 | 9.88 | 3.73 | | 1.603 | 5.559 | 62.952 | |
| 12 | | 0.175 | 2.86 | 3.74 | 8.0 | 0.515 | 2.708 | 105.768 | |
| 13 | 20 g/l | 0.200 | 1.99 | 3.73 | 8.0 | 0.516 | 2.279 | 109.82 | |
| 14 | High Ester Pectin | 0.075 | 7.58 | 3.73 | 10.5 | | | | |
| | (DE 68-74%) #47 | | | | | | | | |
| 15 | | 0.100 | 15.94 | 3..73 | | | | | |
| 16 | | 0.125 | 13.06 | 3.72 | | 2.637 | 7.266 | 45.136 | |
| 17 | | 0.150 | 5.43 | 3.74 | 9.0 | 0.695 | 4.740 | 96.923 | |
| 18 | | 0.175 | 3.28 | 3.75 | 8.0 | 0.560 | 3.823 | 109.372 | |
| 19 | 20 g/l | 0.200 | 2.31 | 3.77 | 8.0 | 0.525 | 2.313 | 102.486 | |

The difference between the comparative examples, where the soy protein beverage is produced using only one homogenization step and the soy protein beverage produced by the two step homogenization of the present invention is demonstrated in the following figures. In each of the figures, a specific soy protein beverage compositions, each containing a certain pectin, are compared on the basis of whether one or two homogenization steps were preformed.

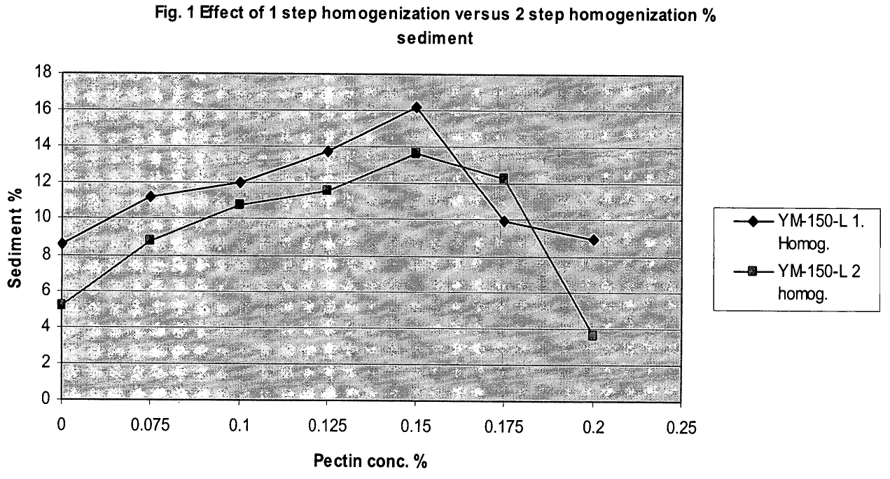

In FIG. 1, the inventive 2 step homogenization process was compared to comparative examples containing the same high ester pectin (YM-150-L), available from CP Kelco ApS. The values used to populate the chart of FIG. 1 are found in the following table.

| | YM-150-L 1. | YM-150-L 2 |
|---|---|---|
| | Homog. | Homog |
| Pectin Conc. % | Sediment % | Sediment % |
| 0.000 | 8.56 | 5.12 |
| 0.075 | 11.18 | 8.73 |
| 0.100 | 12.02 | 10.75 |
| 0.125 | 13.77 | 11.59 |
| 0.150 | 16.21 | 13.64 |
| 0.175 | 9.91 | 12.29 |
| 0.200 | 8.98 | 3.59 |

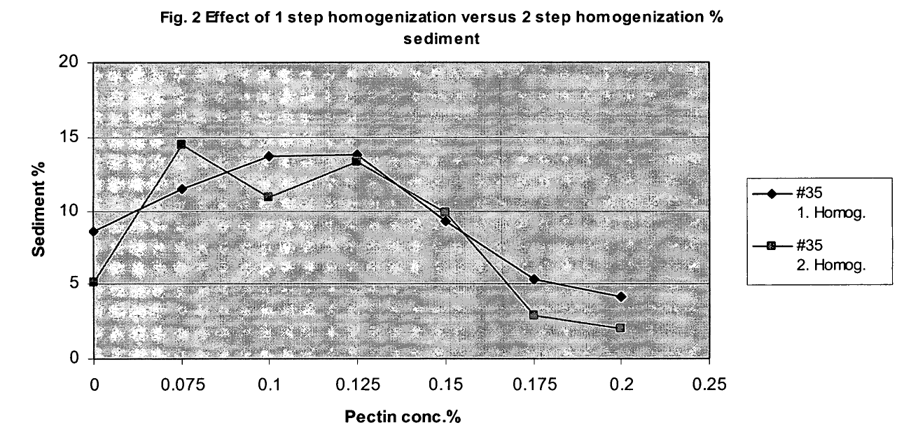

In FIG. 2, the inventive 2 step homogenization process was compared to comparative examples containing the same high ester pectin (#35), produced by CP Kelco ApS. The values used to populate the chart of FIG. 2 are found in the following table.

| | #35 | #35 |
|---|---|---|
| | 1. Homog. | 2. Homog. |
| Pectin Conc. % | Sediment % | Sediment % |
| 0.000 | 8.56 | 5.12 |
| 0.075 | 11.53 | 14.53 |
| 0.100 | 13.74 | 10.94 |
| 0.125 | 13.86 | 13.38 |
| 0.150 | 9.32 | 9.88 |
| 0.175 | 5.28 | 2.86 |
| 0.200 | 4.18 | 1.99 |

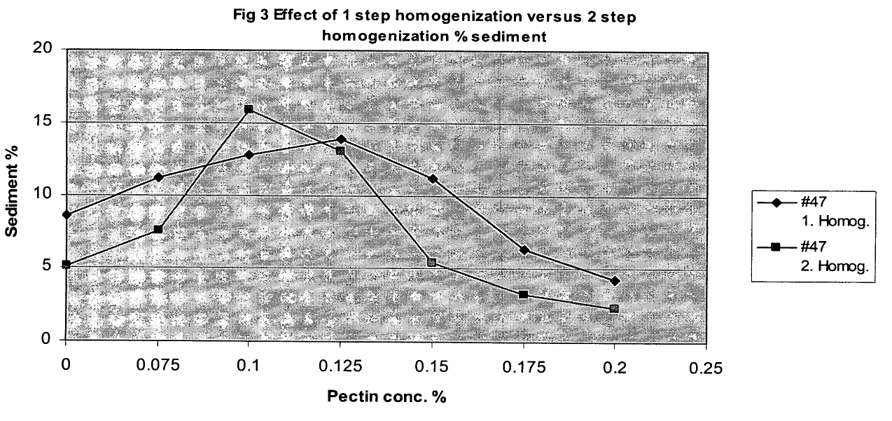

In FIG. 3, the inventive 2 step homogenization process was compared to comparative examples containing the same high ester pectin (#47), produced by CP Kelco ApS. The values used to populate the chart of FIG. 2 are found in the following table.

| | #35 | #35 |
|---|---|---|
| | 1. Homog. | 2. Homog. |
| Pectin Conc. % | Sediment % | Sediment % |
| 0.000 | 8.56 | 5.12 |
| 0.075 | 11.17 | 7.58 |
| 0.100 | 12.72 | 15.94 |
| 0.125 | 13.90 | 13.06 |
| 0.150 | 11.15 | 5.43 |
| 0.175 | 6.37 | 3.28 |
| 0.200 | 4.26 | 2.31 |

The invention being thus described, it will be obvious that the same may be varied in many ways. Such variations are not be regarded as a departure from the spirit and scope of the invention, and all such modifications as would be obvious to one skilled in the art are intended to be included within the scope of the following claims.

I claim:

1. The process of producing an essentially stable aqueous suspension of protein comprising the steps of;
a. obtaining a protein material,
b. dispersing the protein material in an aqueous solution comprising water to form an aqueous protein dispersion,
c. homogenizing the aqueous protein dispersion to form an initial homogenized aqueous protein dispersion,
d. adding an effective amount of a stabilizer to the initial homogenized aqueous protein dispersion and acidifying the initial homogenized protein dispersion,
e. homogenizing the initial homogenized aqueous protein dispersion to form an essentially stable aqueous suspension of protein.

2. The process of claim 1 wherein the protein material may be selected from the list consisting of soy protein, milk protein, and egg protein.

3. The process of claim 2, wherein the soy protein is a soy protein isolate.

4. The process of claim 1 wherein the stabilizer is selected from the group consisting of pectin, carrageenan, soybean fiber, carboxy methyl cellulose (CMC), and propylene glycol alginates (PGA).

5. The process of claim 4, where the stabilizer comprises pectins.

6. The process of claim 5 wherein the pectin further comprises a high ester pectin.
